(19) United States
(12) Patent Application Publication
(10) Pub. No.: US 2002/0146171 A1
(43) Pub. Date: Oct. 10, 2002

(54) Method, apparatus and system for black segment detection

(75) Inventor: Adith Chandrasekhar, Austin, TX (US)

Correspondence Address: SIMON, GALASSO & FRANTZ PLC., P.O. Box 26503, Austin, TX, 26503, US

(73) Assignee: Applied Science Fiction, Inc.

(21) Appl. No.: 09/966,583

(22) Filed: Sep. 28, 2001

Related U.S. Application Data
(60) Provisional application No. 60/237,776, filed on Oct. 1, 2000.

(51) Int. Cl. G06K 9/00

(52) U.S. Cl. 382/181

(57) ABSTRACT

The present invention provides a method, apparatus and system for detecting black segments and selecting a dark area in film or digital images. The present invention identifies one or more areas having a substantially uniform gray level within the digital image, determining an effective darkness value for each identified area, and selects the dark area corresponding to the identified area having the highest effective darkness value. The gray level of the dark area can then be used as the black level in a normalization process.

### CROSS REFERENCE TO RELATED APPLICATIONS

This application claims benefit under 35 U.S.C. §119 of U.S. Provisional Patent Application Serial No. 60/237,776, entitled Method, Apparatus And System For Black Segment Detection, which was filed on Oct. 1, 2000.

### FIELD OF THE INVENTION

The present invention relates generally to image processing, and more particularly to black segment detection in digital film processing.

### BACKGROUND OF THE INVENTION

Digital images are becoming more popular with consumers, especially as people become accustomed to sending and receiving information over the Internet. Waiting more than a few seconds for an image can be excruciating to many people. Photographs from an analog camera, however, may take days to develop. The fastest way to receive analog photographs at the present time is by taking exposed film to one of the many popular “One-Hour” developers.

The developers process the film and return negatives and prints on photo paper to the customer. This process is typically completed within one hour. Prints, however, are relatively useless if the customer wants to transmit the photographs through a network or manipulate them with a computer. Since computers perform operations digitally, a photograph must be digitized before it can be loaded into a computer. Digitizing a photograph requires a scanner, which increases costs. Also, scanning an analog image involves an inherent loss of resolution.

Applied Science Fiction, Inc. has developed digital film processing to directly digitize an image from exposed photographic film. This process eliminates the expense and resolution losses associated with digitizing photographs using a scanner. The images are stored directly into a digital format that the consumer may instantly transmit through a network or view on a computer screen.

During digital film processing the digital image is normalized using a value for black and a value for white. Typically the value for black is determined from pixels from within the area of the exposed leader of the negative that have low gray levels. Conventional methods for normalization require the intervention of a trained photographic laboratory technician to scan each negative to locate the exposed leader and visually identify an area of dark pixels spread over a relatively large area. This approach results in inconsistency in selecting values used for normalization and also inefficiency due to the long time required for hand selection.

In addition, the leader section of a film is almost always overexposed to light at the time the film is loaded into a camera. As a result, this section of the film is always considerably darker than its immediate surrounding areas. Selecting the darkest point on the leader does not consistently provide an optimum black level because the darkest point is not usually representative of a black portion of the images that need to be normalized. What is desirable is finding an area of very dark pixels spread over a large, contiguous area within the area of the leader of the film.

As a result, there is a need for a method, apparatus and system for detecting black segments, which are large, contiguous areas of very dark pixels, and thus determining optimum black values quickly and consistently from exposed film leaders.

### SUMMARY OF THE INVENTION

The present invention provides a method, apparatus and system for detecting black segments, which are large, contiguous areas of very dark pixels, and thus determining optimum black values quickly and consistently from exposed film leaders. More specifically, the present invention provides a method, apparatus and system for selecting a dark area within a film or digital image. The gray level of the selected dark area is then used to determine the optimum black level to normalize the images being processed.

More specifically, the present invention provides a method for selecting a dark area in a digital image having a number of columns, each column having a number of pixels and each pixel having a gray level. The method includes the steps of identifying one or more areas having a substantially uniform gray level within the digital image, determining an effective darkness value for each identified area, and selecting the dark area corresponding to the identified area having the highest effective darkness value.

In addition, the present invention provides a method for selecting a dark area within a film by creating a digital image by scanning the film and cropping the digital image. The cropped digital image contains a number of columns, each column having a number of pixels, each pixel having a gray level. The present invention then samples the columns, determines an average gray level for each sampled column, determines a partial derivative of the average gray level for the sampled columns, and filters the partial derivative. Thereafter, one or more areas are identified using the filtered partial derivative, and an effective darkness value is determined for each identified area. A dark area is then selected which corresponds to the identified area having the highest effective darkness value.

The present invention also provides a computer program embodied on a computer readable medium for selecting a dark area in a digital image having a number of columns, each column having a number of pixels and each pixel having a gray level. The computer program includes a code segment for identifying one or more areas having a substantially uniform gray level within the digital image, a code segment for determining an effective darkness value for each identified area, and a code segment for selecting the dark area corresponding to the identified area having the highest effective darkness value.

In addition, the present invention provides a computer program embodied on a computer readable medium for selecting a dark area within a film. The computer program includes a code segment for creating a digital image by scanning the film and a code segment for cropping the digital image. The cropped digital image includes a number of columns, each column having a number of pixels, each pixel having a gray level. The computer program also includes a code segment for sampling the columns, a code segment for determining an average gray level for each sampled column, a code segment for determining a partial derivative of the average gray level for the sampled columns, a code segment for filtering the partial derivative, a code segment for identifying one or more areas using the filtered partial derivative, a code segment for determining an effective darkness value for each identified area, and a code segment for selecting a dark area corresponding to the identified area having the highest effective darkness value.

The present invention also provides an imaging system having at least one light source operable to illuminate a film, at least one optical sensor operable to detect light from the film, and an image processor coupled to the optical sensors. The image processor creates a digital image from the light detected by the optical sensors, identifies one or more areas having a substantially uniform gray level within the digital image, determines an effective darkness value for each identified area, selects a dark area corresponding to the identified area having the highest effective darkness value, and normalizes the digital image using the dark area.

Other features and advantages of the present invention shall be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings in which corresponding numerals in the different figures refer to corresponding parts in which:

FIG. 1 is a perspective view of a scanning device in accordance with a digital film processing system;

FIG. 2 is an illustration of a duplex film processing system in accordance with a digital film processing system;

FIG. 3 depicts a black segment detection process, which selects a dark area in a digital image, in accordance with one embodiment of the present invention;

FIG. 4 depicts a black segment detection process, which selects a dark area in a digital image, in accordance with one embodiment of the present invention; and

FIGS. 5A, 5B, 5C, 5D, 5E and 5F depict an example of the black segment detection process, which selects a dark area in a digital image, in accordance with one embodiment of the present invention.

### DETAILED DESCRIPTION

While the making and using of various embodiments of the present invention are discussed herein in terms of a digital film processing system using photographic media, it should be appreciated that the present invention provides many applicable inventive concepts which can be embodied in a wide variety of specific contexts. For example, the present invention can be used in any image processing system where an optimum value for black is needed. The specific embodiments discussed herein are merely illustrative of specific ways to make and use the invention and do not delimit the scope of the invention.

The present invention provides a method, apparatus and system for detecting black segments, which are large, contiguous areas of very dark pixels, and thus determining optimum black values quickly and consistently from exposed film leaders. More specifically, the present invention provides a method, apparatus and system for selecting a dark area within a film or digital image. The gray level of the selected dark area is then used and the optimum black level to normalize the images being processed.

The term “film” is used hereinafter to refer to any unrestricted length of material. The film may or may not have aligned and evenly spaced perforations, which are hereinafter referred to as “sprocket holes.” Camera or motion picture film is, of course, a primary example, but the present invention is not to be construed to be limited to a film for still camera or even motion picture film. The film may be a strip of material for other purposes as well.

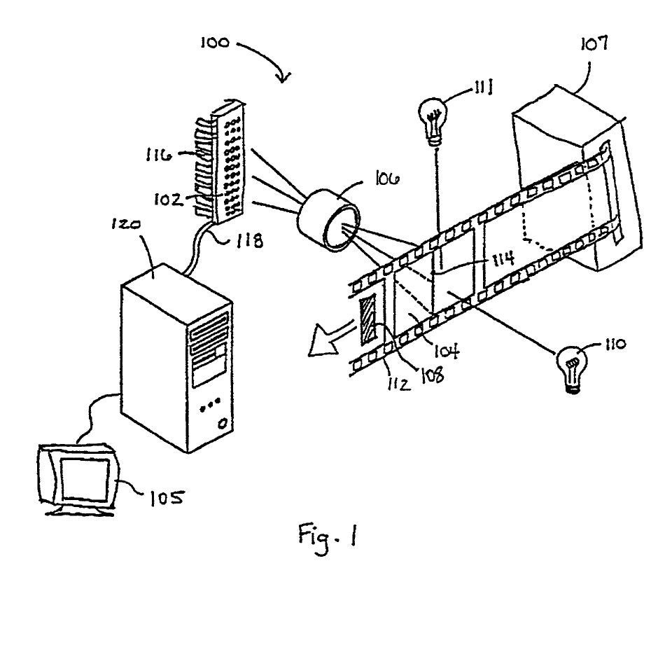

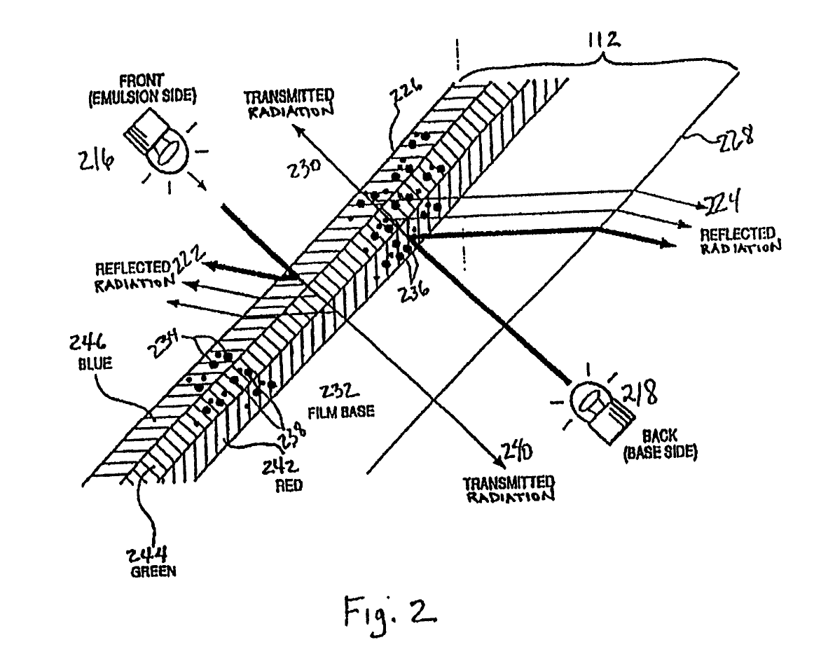

A digital film scanning apparatus is shown in FIG. 1. The scanning apparatus 100 operates by converting electromagnetic radiation from an image to an electronic (digital) representation of the image. The image being scanned is typically embodied in a physical form, such as on a photographic media, i.e., film, although other media may be used. In general, the electromagnetic radiation used to convert the image into a digitized representation is preferably infrared light. The scanning apparatus 100 generally includes a number of optic sensors 102. The optic sensors 102 measure the intensity of electromagnetic energy passing through or reflected by the film 112. The source of electromagnetic energy is typically a light source 110 which illuminates the film 112 containing the scene image 104 and the reference patch image 108 to be scanned. Radiation from the source 110 may be diffused or directed by additional optics such as filters (not shown) and one or more lenses 106 positioned near the sensors 102 and the film 112 in order to illuminate the images 104 and 108 more uniformly. Furthermore, more than one source may be used. Source 110 is positioned on the side of the film 112 opposite the optic sensors 102. This placement results in sensors 102 detecting radiation emitted from source 110 as it passes through the image 104 on the film 112. Another light source 111 is shown placed on the same side of the film 112 as the sensors 102. When source 111 is activated, sensors 102 detect radiation reflected by the images 104 and 108. This process of using two sources positioned on opposite sides of the film 112 being scanned is described in more detail below in conjunction with FIG. 2.

The optic sensors 102 are generally geometrically positioned in arrays such that the electromagnetic energy striking each optical sensor 102 corresponds to a distinct location 114 in the images 104 and 108. Accordingly, each distinct location 114 in the scene image 104 corresponds to a distinct location, referred to as a picture element, or “pixel” for short, in the scanned, or digitized image 105. The image 104 on film 112 are usually sequentially moved, or scanned, across the optical sensors 102. The optical sensors 102 are typically housed in a circuit package 116 that is electrically connected, such as by cable 118, to supporting electronics for computer data storage and processing, shown together as computer 120. Computer 120 may then process the digitized image 105. Alternatively, computer 120 may be replaced with a microprocessor and cable 118 replaced with an electrical circuit connection.

Optical sensors 102 may be manufactured from different materials and by different processes to detect electromagnetic radiation in varying parts and bandwidths of the electromagnetic spectrum. The optical sensor 102 may include a photodetector (not expressly shown) that produces an electrical signal proportional to the intensity of electromagnetic energy striking the photodetector. Accordingly, the photodetector measures the intensity of electromagnetic radiation attenuated by the image 104 on film 112.

Turning now to FIG. 2, a conventional color film 112 is depicted. As previously described, the present invention uses duplex film scanning that refers to using a front source 216 and a back source 218 to scan the film 112 with reflected radiation 222 from the front 226 and reflected radiation 224 from the back 228 of the film 112 and by transmitted radiation 230 and 240 that passes through all layers of the film 112. While the sources 216, 218 are generally monochromatic and preferable infrared. The respective scans, referred to herein as front, back, front-through and back-through, are further described below.

In FIG. 2, separate color levels are viewable within the film 112 during development of the red layer 242, green layer 244 and blue layer 246. Over a clear film bases 232 are three layers 242, 244, 246 sensitive separately to red, green and blue light, respectively. These layers are not physically the colors; rather, they are sensitive to these colors. In conventional color film development, the blue sensitive layer 246 would eventually develop a yellow dye, the green sensitive layer 244 a magenta dye, and the red sensitive layer 242 a cyan dye.

During development, layers 242, 244, and 246 are opalescent. Dark silver grains 234 developing in the top layer 246, the blue source layer, are visible from the front 226 of the film, and slightly visible from the back 228 because of the bulk of the opalescent emulsion. Similarly, grains 236 in the bottom layer 242, the red sensitive layer, are visible from the back 228 by reflected radiation 224, but are much less visible from the front 226. Grains 238 in the middle layer 244, the green sensitive layer, are only slightly visible to reflected radiation 222, 224 from the front 226 or the back 228. However, they are visible along with those in the other layers by transmitted radiation 230 and 240. By sensing radiation reflected from the front 226 and the back 228 as well as radiation transmitted through the film 112 from both the front 226 and back 228 of the film 112, each pixel for the film 112 yields four measured values, one from each scan, that may be mathematically processed in a variety of ways to produce the initial three colors, red, green and blue, closest to the original scene.

The front signal records the radiation 222 reflected from the illumination source 216 in front he the film 112. The set of front signals for an image is called the front channel. The front channel principally, but not entirely, records the attenuation in the radiation from the source 216 due to the silver metal particles 234 in the top-most layer 246, which is the blue recording layer. There is also some attenuation of the front channel due to silver metal particles 236, 238 in the red and green layers 242, 244.

The back signal records the radiation 224 reflected from the illumination source 218 in back of the film 112. The set of back signals for an image is called the back channel. The back channel principally, but not entirely, records the attenuation in the radiation from the source 218 due to the silver metal particles 236 in the bottom-most layer 242, which is the red recording layer. Additionally, there is some attenuation of the back channel due to silver metal particles 234, 238 in the blue and green layers 246, 244.

The front-through signal records the radiation 230 that is transmitted through the film 112 from the illumination source 218 in back of the film 112. The set of front-through signals for an image is called the front-through channel. Likewise, the back-through signal records the radiation 240 that is transmitted through the film 112 from the source 216 in front of the film 112. The set of back-through signals for an image is called the back-through channel. Both through channels record essentially the same image information since they both record the attenuation of the radiation 230, 240 due to the silver metal particles 234, 236, 238 in all three red, green, and blue recording layers 242, 244, 246 of the film 112.

Several image processing steps are required to convert the illumination source radiation information for each channel to the red, green, and blue values similar to those produced by conventional scanners for each spot on the film 112. These steps are required because the silver metal particles 234, 236, 238 that form during the development process are not spectrally unique in each of the film layers 242, 244, 246. While the present invention is described in context of a digital film processing system, it is understood that conventional scanners could also be used.

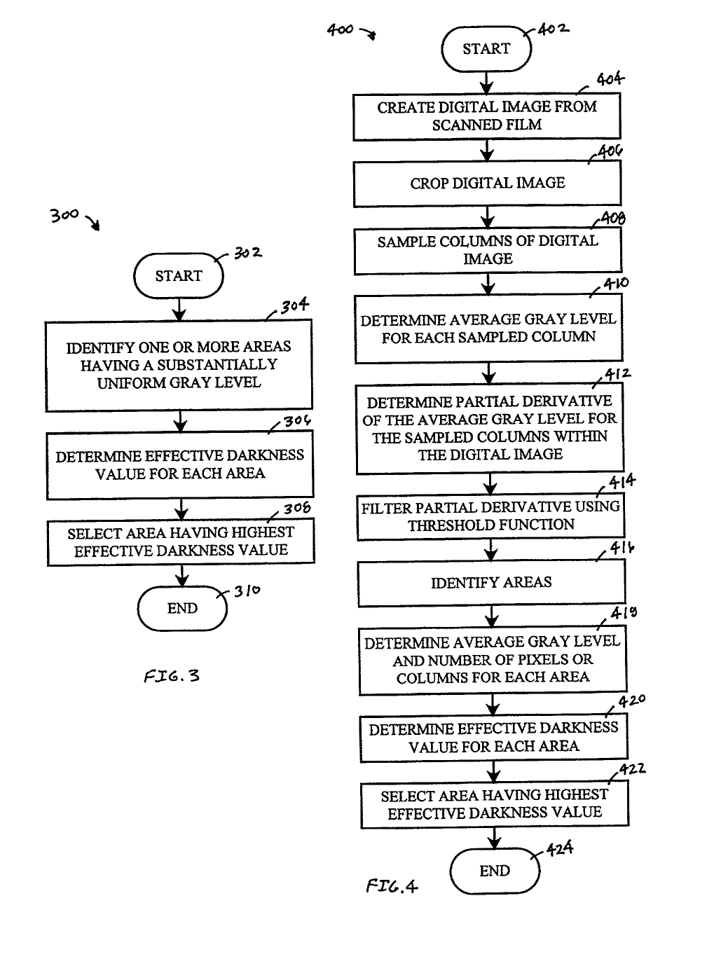

Now referring to FIG. 3, a black segment detection process 300 which selects a dark area in a digital image in accordance with one embodiment of the present invention is shown. Note that the digital image has a number of columns, each column has a number of pixels and each pixel has a gray level. In addition, only one channel of data (see FIG. 2) is necessary to selected the dark area. The process 300 starts in block 302 and identifies one or more areas having a substantially uniform gray level within the digital image in block 304. An effective darkness value is then determined for each identified area in block 306. A dark area is then selected that corresponds to the identified area having the highest effective darkness value in block 308. The process ends in block 310. The gray level of the dark area is then used as the optimum black value during normalization of the digital images scanned from the film.

The identification of one or more areas having a substantially uniform gray level within the digital image in block 304 may include several steps, such as determining an average gray level for each column, determining a partial derivative of the average gray level for the columns, and identifying one or more areas using the partial derivative. The partial derivative of the average gray level for the columns can be determined by averaging the average gray level of pixels within a column with the average darkness level of pixels within a succeeding column. The results of the partial derivative can be made more robust by first sampling the columns of the digital image and then taking the partial derivative of the average gray level of the sampled columns. Filtering the partial derivative also improves the results. One way of filtering the partial derivative is by using a threshold function.

In block 306, the effective darkness value for each identified area may be determined by weighting a gray level of the identified area with a size value of the identified area. The gray level of each identified area may be an average gray level of the pixels within the identified area, or a median gray level of the pixels within the identified area. The size value of each identified area may be the number of pixels within the identified area, or the number of columns within the identified area.

Referring now to FIG. 4, a black segment detection process 400 which selects a dark area in a digital image in accordance with one embodiment of the present invention is shown. Process 400 starts in block 402 and a digital image is created by scanning film in block 404. The digital image is then cropped in block 406 to delete a specified number of rows of pixels from the top and bottom of the digital image that contain the area around the film sprocket holes. The areas around the sprocket holes are deleted because these areas contain spurious gray level information which is unrelated to finding the optimal black level. In the case of 35 mm film, the top and bottom 64 rows of pixels are deleted. Next, the columns of the cropped digital image are sampled in block 408. Sampling the columns of the cropped digital image provides several advantages over using the complete or high resolution digital image. Sampling improves the results of the partial derivative step in block 412. Sampling also reduces the amount of memory required and the amount of time required to select the dark area. In the case of 35 mm film, sampling every eighth column provides very good results. Typically in such a case, the dark area will be found within the first 2048 sampled columns of the digital image. Other sampling rates may also be used.

The average gray level of the pixels within each sampled column, μ(X), is determined in block 410 according to the following formula:

$$μ ( X ) = \frac{1}{N} {\sum }_{Y = 0}^{N - 1} f ( X , Y )$$

The sampled digital image of the film roll is represented by ƒ(X, Y) and has dimensions M×N pixels. X and Y represent the x and y coordinates respectively of each pixel.

Areas of uniform gray level along the length of the film can be determined by taking the partial derivative along the x direction. The partial derivative of the average gray level for the sampled columns within the digital image are determined in block 412. The general formula for calculating ƒ′(X) is given as:

$${f}^{′} ( X ) = \frac{\partial }{\partial X} \int f ( X , Y ) ⅆ Y$$

In the discrete case, where ƒ(X, Y) is an image of dimensions M×N pixels, ƒ′(X) is determined as follows:

$${f}^{′} ( X ) = \frac{μ ( X + 2 ) - μ ( X )}{2}$$

Because parameters required for determining ƒ′(M−1) and ƒ′(M−2) lie outside of the sample set for the digital image, the results for ƒ′(M−1) and ƒ′(M−2) are set to “0”.

To further distinguish the areas having more uniform gray levels, the partial derivative ƒ′(X) is filtered using a threshold function in block 414. For each value of ƒ′(X) over an appropriately set threshold value, t, the corresponding value of T(X) is set to “0”. For each value of ƒ′(X) equal to or less than the appropriately set threshold value, t, the corresponding value of T(X) is set to “1”.

$$T ( X ) = \{ \begin{matrix}0 if \vert {f}^{′} ( X ) \vert > t \\ 1 if \vert {f}^{′} ( X ) \vert \leq t\end{matrix}$$

For example, a threshold value t of “4” works well with a sampling rate of “8” so that all sharp edges along the length of the film are represented as “0's” in T(X) and all areas of nearly uniform gray levels are represented as “1's” in T(X). Each sequence of successive “1's” in T(X) represents an area of nearly uniform gray levels and is identified by giving each area a separate and unique label in block 416 according to a Connected Component Labeling algorithm. (See Gonzalez, et al., Digital Image Processing, Addison-Wesley, Reading, Mass., 1992.) Each area of nearly uniform gray level is separated from other such area by elements of the T(X) array having a value of “0”, which values of “0” represent edges.

Each identified area is examined to determine the “brightness” (e.g. average gray level) of the entire area by calculating either a median or average of the magnitude or gray levels of all of the pixels that are contained within the identified area in block 418. The number of pixels or the number of columns within the identified area are also determined in block 418. If ν is defined as the brightness of the identified area, wherein the brightness is directly proportional to the magnitude of the pixel,

ν=Median(μ(Xρ))

or

$$v = \frac{1}{N ρ} {\sum }_{X ρ} μ ( X ρ )$$

where Xρ represents each pixel belonging to an identified area P and Nρ is defined as the number of pixels in the identified area. Optionally, areas containing less than 300 columns (for a sample set of 2048 columns) may be ignored for the purposes of selecting the black area.

Be cause ν represents the brightness of an identified area, ν must be complemented to determine the “darkness” of an area for the purpose of finding the darkest area covering the largest area. If ν is made to vary such that 0≦ν≦1, the number of equivalent pixels (i.e. the effective darkness value of an area) can be calculated according to:

ε(P)=(1−ν)Nρ

where ε is defined as the effective darkness value of the identified area or the number of equivalent pixels in the identified area, and Nρ is defined as the number of pixels or the number of columns in the identified area. The effective darkness value is calculated for each identified area in block 420 and the identified area with the highest effective darkness value is selected in block 422 to be the black area. Thereafter, the black segment detection process ends in block 424 when the location of the black area is provided to the normalization routine of the image processing system. The normalization routine uses values from the black area to determine the optimum black level for processing the digital images. Alternatively, the black segment detection process may determined the average gray level of the dark area and provide that data directly to the normalization routine.

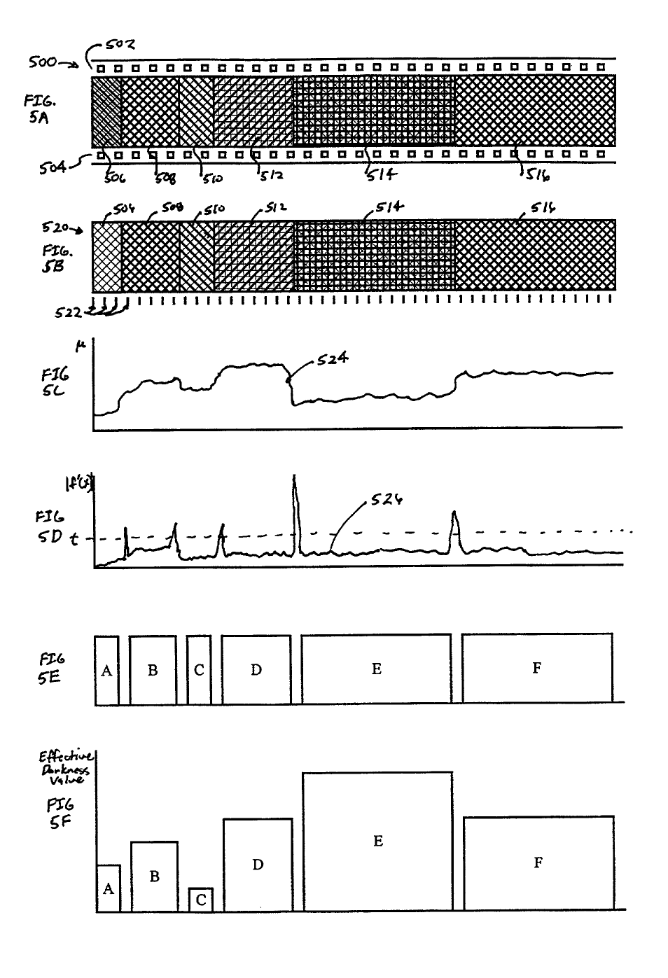

FIGS. 5A, 5B, 5C, 5D, 5E and 5F depict an example of the black segment detection process, which selects a dark area in a digital image, in accordance with one embodiment of the present invention. In FIG. 5A, the leader portion 500 of film 112 (FIGS. 1 and 2) is shown having a top sprocket hole area 502, a bottom sprocket hole area 504 and several areas 506, 508, 510, 512, 514 and 516. Each area 506, 508, 510, 512, 514 and 516 has a substantially uniform, but different, gray level associated with it, as indicated by the cross hatching.

FIG. 5B represents a digital image 520 after the top and bottom sprocket hole areas 502 and 504 (FIG. 5A) have been cropped. The areas 502 and 504 (FIG. 5A) are deleted because these areas contain spurious gray level information which is unrelated to finding the optimal black level. In the case of 35 mm film, the top and bottom 64 rows of pixels are deleted. In one embodiment, the digital image 520 is represented as a bi-dimensional array of pixels with an 8-bit word representing the monochromatic value or gray level of each pixel (0 to 255) and with the x-axis of the array aligned along the direction of travel of the film 112 (FIGS. 1 and 2). Next, the columns of the cropped digital image 520 are sampled. The sampled columns are indicated by lines 522. Sampling the columns of the cropped digital image 520 provides several advantages over using the complete or high resolution digital image. Sampling improves the results of the partial derivative step (see FIG. 5D). Sampling also reduces the amount of memory required and the amount of time required to select the dark area. In the case of 35 mm film, sampling every eighth column provides very good results. Typically in such a case, the dark area will be found within the first 2048 sampled columns of the digital image. Other sampling rates may also be used.

Now referring to FIGURE SC, the average gray level μ(X) of the pixels within each sampled column 522 (FIG. 5B) are determined and represented by line 524. Areas of uniform gray level 506, 508, 510, 512, 514 and 516 along the length of the film 112 can be determined by taking the partial derivative ƒ′(X) of the average gray level μ(X) for the sampled columns 522 (FIG. 5B) along the x direction.

FIG. 5D shows the absolute value of the partial derivative |ƒ′(X)| of the average gray level for the sampled columns μ(X) within the digital image 520 (FIG. 5B) and is represented by line 526. To further distinguish the areas 506, 508, 510, 512, 514 and 516 having more uniform gray levels, the partial derivative ƒ′(X), represented by line 526, is filtered using a threshold function. As illustrated in FIG. 5E, for each value of ƒ′(X), represented by line 526 (FIG. 5D), over an appropriately set threshold value, t, the corresponding value of T(X) is set to “0”. For each value of ƒ′(X) equal to or less than the appropriately set threshold value, t, the corresponding value of T(X) is set to “1”. For example, a threshold value t of “4” works well with a sampling rate of “8” so that all sharp edges along the length of the film 112 are represented as “0's” in T(X) and all areas of nearly uniform gray levels are represented as “1's” in T(X). Each sequence of successive “1's” in T(X) represents an area of nearly uniform gray levels and is identified by giving each area a separate and unique label A, B, C, D, E and F according to a Connected Component Labeling algorithm. (See Gonzalez, et al., Digital Image Processing, Addison-Wesley, Reading, Mass., 1992.) The areas of nearly uniform gray level A, B, C, D, E and F are separated from each other by elements of the T(X) array having a value of “0”, which values of “0” represent edges. Optionally, areas containing less than 300 columns (for a sample set of 2048 columns) may be ignored for the purposes of selecting the black area.

Now referring to FIGURE SF, each identified area A, B, C, D, E and F is examined to determine the “brightness” (e.g. average gray level) of the entire area by calculating either a median or average of the magnitude or gray levels of all of the pixels that are contained within the identified area A, B, C, D, E and F. The number of pixels or the number of columns within the identified area A, B, C, D, E and F are also determined. The effective darkness value of each identified area A, B, C, D, E and F is determined by weighting the complement of the average gray level for the identified area A, B, C, D, E and F by the size value of the identified area A, B, C, D, E and F. The size value may be the number of pixels or the number of columns within the identified area A, B, C, D, E and F. The identified area with the highest effective darkness value, which is identified area E in this example, is then selected to be the black area. Thereafter, the black segment detection process ends in block 424 when the location of the black area is provided to the normalization routine of the image processing system. The normalization routine uses values from the black area to determine the optimum black level for processing the digital images. Alternatively, the black segment detection process may determined the average gray level of the dark area and provide that data directly to the normalization routine.

The present invention is useful in any film processing application. The invention is most advantageous where consistency and speed is desired in processing digital images from photographic negatives. Although preferred embodiments of the invention have been described in detail, it will be understood by those skilled in the art that various modifications can be made therein without departing from the spirit and scope of the invention as set forth in the appended claims.

What is claimed is:

1. A method for selecting a dark area in a digital image having a number of columns, each column having a number of pixels and each pixel having a gray level, the method comprising the steps of:
identifying one or more areas having a substantially uniform gray level within the digital image;
determining an effective darkness value for each identified area; and
selecting the dark area corresponding to the identified area having the highest effective darkness value.

2. The method as recited in claim 1, wherein the step of identifying one or more areas having a substantially uniform gray level within the digital image comprises the steps of:
determining an average gray level for each column;
determining a partial derivative of the average gray level for the columns; and
identifying one or more areas using the partial derivative.

3. The method as recited in claim 2, wherein the partial derivative of the average gray level for the columns comprises averaging the average gray level of pixels within a column with the average gray level of pixels within a succeeding column.

4. The method as recited in claim 2, further comprising the step of sampling the columns of the digital image.

5. The method as recited in claim 2, further comprises the step of filtering the partial derivative.

6. The method as recited in claim 5, wherein the step of filtering the partial derivative uses a threshold function.

7. The method as recited in claim 1, wherein the step of determining an effective darkness value for each identified area comprises weighting a complement of a gray level of the identified area with a size value of the identified area.

8. The method as recited in claim 7, wherein the gray level of each identified area comprises an average gray level of the pixels within the identified area.

9. The method as recited in claim 7, wherein the gray level of each identified area comprises a median gray level of the pixels within the identified area.

10. The method as recited in claim 7, wherein the size value of each identified area comprises the number of pixels within the identified area.

11. The method as recited in claim 7, wherein the size value of each identified area comprises the number of columns within the identified area.

12. A method for selecting a dark area within a film comprising the steps of:
creating a digital image by scanning the film;
cropping the digital image, the cropped digital image having a number of columns, each column having a number of pixels, each pixel having a gray level;
sampling the columns;
determining an average gray level for each sampled column;
determining a partial derivative of the average gray level for the sampled columns;
filtering the partial derivative;
identifying one or more areas using the filtered partial derivative;
determining an effective darkness value for each identified area; and
selecting a dark area corresponding to the identified area having the highest effective darkness value.

13. The method as recited in claim 12, wherein the partial derivative of the average gray level for the sampled columns comprises averaging the average gray level of pixels within a sampled column with the average gray level of pixels within a succeeding sampled column.

14. The method as recited in claim 12, wherein the step of filtering the partial derivative uses a threshold function.

15. The method as recited in claim 12, wherein the step of determining an effective darkness value for each identified area comprises weighting a complement of a gray level of the identified area with a size value of the identified area.

16. The method as recited in claim 15, wherein the gray level of each identified area comprises an average gray level of the pixels within the identified area.

17. The method as recited in claim 15, wherein the gray level of each identified area comprises a median gray level of the pixels within the identified area.

18. The method as recited in claim 15, wherein the size value of each identified area comprises the number of pixels within the identified area.

19. The method as recited in claim 15, wherein the size value of each identified area comprises the number of columns within the identified area.

20. The method as recited in claim 12, further comprising the step of reporting the location the dark area to an image processor.

21. The method as recited in claim 12, further comprising the steps of:
determining an average gray level for the dark area; and
reporting the average gray level for the dark area to an image processor.

22. A computer program embodied on a computer readable medium for selecting a dark area in a digital image having a number of columns, each column having a number of pixels and each pixel having a gray level, the computer program comprising:
a code segment for identifying one or more areas having a substantially uniform gray level within the digital image;
a code segment for determining an effective darkness value for each identified area; and
a code segment for selecting the dark area corresponding to the identified area having the highest effective darkness value.

23. The computer program as recited in claim 22, wherein the code segment for identifying one or more areas having a substantially uniform gray level within the digital image comprises:
a code segment for determining an average gray level for each column;
a code segment for determining a partial derivative of the average gray level for the columns; and
a code segment for identifying one or more areas using the partial derivative.

24. The computer program as recited in claim 23, wherein the partial derivative of the average gray level for the columns comprises averaging the average gray level of pixels within a column with the average gray level of pixels within a succeeding column.

25. The computer program as recited in claim 23, further comprising a code segment for sampling the columns of the digital image.

26. The computer program as recited in claim 23, further comprising a code segment for filtering the partial derivative.

27. The computer program as recited in claim 26, wherein the code segment for filtering the partial derivative uses a threshold function.

28. The computer program as recited in claim 22, wherein the code segment for determining an effective darkness value for each identified area comprises weighting a complement of a gray level of the identified area with a size value of the identified area.

29. The computer program as recited in claim 28, wherein the gray level of each identified area comprises an average gray level of the pixels within the identified area.

30. The computer program as recited in claim 28, wherein the gray level of each identified area comprises a median gray level of the pixels within the identified area.

31. The computer program as recited in claim 28, wherein the size value of each identified area comprises the number of pixels within the identified area.

32. The computer program as recited in claim 28, wherein the size value of each identified area comprises the number of columns within the identified area.

33. A computer program embodied on a computer readable medium for selecting a dark area within a film comprising:
a code segment for creating a digital image by scanning the film;
a code segment for cropping the digital image, the cropped digital image having a number of columns, each column having a number of pixels, each pixel having a gray level;
a code segment for sampling the columns;
a code segment for determining an average gray level for each sampled column;
a code segment for determining a partial derivative of the average gray level for the sampled columns;
a code segment for filtering the partial derivative;
a code segment for identifying one or more areas using the filtered partial derivative;
a code segment for determining an effective darkness value for each identified area; and
a code segment for selecting a dark area corresponding to the identified area having the highest effective darkness value.

34. The computer program as recited in claim 33, wherein the partial derivative of the average gray level for the sampled columns comprises averaging the average gray level of pixels within a sampled column with the average gray level of pixels within a succeeding sampled column.

35. The computer program as recited in claim 33, wherein the code segment for filtering the partial derivative uses a threshold function.

36. The method as recited in claim 33, wherein the step of determining an effective darkness value for each identified area comprises weighting a complement of a gray level of the identified area with a size value of the identified area.

37. The computer program as recited in claim 36, wherein the gray level of each identified area comprises an average gray level of the pixels within the identified area.

38. The computer program as recited in claim 36, wherein the gray level of each identified area comprises a median gray level of the pixels within the identified area.

39. The computer program as recited in claim 36, wherein the size value of each identified area comprises the number of pixels within the identified area.

40. The computer program as recited in claim 36, wherein the size value of each identified area comprises the number of columns within the identified area.

41. The computer program as recited in claim 33, further comprising a code segment for reporting the location the dark area to an image processor.

42. The computer program as recited in claim 33, further comprising:
a code segment for determining an average gray level for the dark area; and
a code segment for reporting the average gray level for the dark area to an image processor.

43. An imaging system comprising:
at least one light source operable to illuminate a film;
at least one optical sensor operable to detect light from the film; and
an image processor coupled to the optical sensors, wherein the image processor creates a digital image from the light detected by the optical sensors, identifies one or more areas having a substantially uniform gray level within the digital image, determines an effective darkness value for each identified area, selects a dark area corresponding to the identified area having the highest effective darkness value, and normalizes the digital image using the dark area.

44. The system as recited in claim 43, wherein:
the digital image has a number of columns, each column has a number of pixels, each pixel has a gray level; and
the image processor identifies one or more areas having a substantially uniform gray level within the digital image by determining an average gray level for each column, determining a partial derivative of the average gray level for the columns, and identifying one or more areas using the partial derivative.

45. The system as recited in claim 44, wherein the processor determines the partial derivative of the average gray level for the columns by averaging the average gray level of pixels within a column with the average gray level of pixels within a succeeding column.

46. The system as recited in claim 44, wherein the processor further samples the columns of the digital image.

47. The system as recited in claim 44, wherein the processor further filters the partial derivative.

48. The system as recited in claim 43, wherein the processor determines an effective darkness value for each identified area by weighting a complement of a gray level of the identified area with a size value of the identified area.

49. The system as recited in claim 48, wherein the gray level of each identified area comprises an average gray level of the pixels within the identified area.

50. The system as recited in claim 48, wherein the gray level of each identified area comprises a median gray level of the pixels within the identified area.

51. The system as recited in claim 48, wherein the size value of each identified area comprises the number of pixels within the identified area.

52. The system as recited in claim 48, wherein the size value of each identified area comprises the number of columns within the identified area.

53. The system as recited in claim 43, wherein the processor further crops the digital image.
